(19) United States
(12) Patent Application Publication
(10) Pub. No.: US 2011/0204169 A1
(43) Pub. Date: Aug. 25, 2011

(54) SCREEEN ASSEMBLY FOR A MINERAL PROCESSOR

(76) Inventor: David Pitchford, Alcoa, TN (US)

(21) Appl. No.: 13/016,129

(22) Filed: Jan. 28, 2011

Related U.S. Application Data
(60) Provisional application No. 61/299,560, filed on Jan. 29, 2010.

(51) Int. Cl. B02C 23/08; B07B 1/46; B07B 1/50

(52) U.S. Cl. 241/68; 209/235

(57) ABSTRACT

A screen assembly for use in a minerals processing apparatus comprising an elongate separation screen defining an upper surface having a material reception area towards a first end and a material delivery area towards a second end, so arranged that in use material received onto the material reception area is caused to move toward the material delivery area, the separation screen having a plurality of through apertures configured such that as material so moves toward the material delivery area material components below a predetermined size tend to fall through the apertures and material components above a predetermined size continue to the material delivery area; wherein the separation screen is provided with a cleaner device comprising a support structure having on a surface thereof a plurality of projections arrayed in coincident pattern with at least some of the through apertures in the separation screen, and in that the cleaner device is deployable between a cleaning configuration whereat the support structure is brought into close proximity below the separation screen such that the projections into through their corresponding apertures in the separation screen and an undeployed configuration away from such close proximity. A materials processing apparatus and in particular a mineral sizing system incorporating such a screen assembly.

### CROSS-REFERENCE TO RELATED APPLICATIONS

This present application claims priority to a U.S. Provisional No. 61/299,560, entitled “Screen Assembly for a Mineral Processor,” filed on Jan. 29, 2010, the entire disclosure of which is incorporated herein by reference in its entirety for any and all purposes.

### BACKGROUND OF DISCLOSURE

This invention generally relates to a screen assembly for use in the minerals processing industry and to such an assembly included in a materials processing apparatus, in particular in application in conjunction with a mineral breaker/sizer device which breaks mined material into a predetermined desired size range.

Mined materials can comprise of overburden or ore or a mixture of both and in physical appearance is seen as rocks, soils and lumps of varied sizes. This presents two particular problems to a materials processor. First, it is generally desired to separate the target materials from the waste materials. Second, depending upon the next processing or transport stage for which the material is intended, it is generally necessary to size the material to a predetermined size range, and in particular to achieve this it may be necessary to break larger lumps of the material into smaller pieces of a predetermined size range.

Materials processors have used a variety of methods to break down larger lumps of as-mined material into a desired size range, for example including rotary crushers and breakers which take as-mined material and pass this between counter-rotating toothed rollers where oversized mineral is crushed and/or broken in tension by the rollers and teeth.

The intention of the rotary breakers is to reduce the maximum size of the overburden and ore to a size that can be accepted by downstream equipment and processes. In many applications, however, it is found that a significant amount of the material being delivered to the rotary breakers is already of an acceptable size. It makes sense therefore to separate the already acceptable material from the oversize prior to delivery of material to the rotary breakers in order to reduce the operating energy costs and also the capacity requirements of the rotary breakers when designing the breaking equipment.

The separation can be achieved by screens or grizzlies which are known in the industry. These devices consist of slotted or square grid-like meshes which allow undersize material to pass through and deflect the oversize particles onward to the breaking process. It is already known in the art and the industry to place such screening devices upstream of breaking and crushing machines.

One of the problems with these known screening devices is that they are generally static and are thus prone to encrustation and can easily block up during operation, particularly if the material has a sticky properties (for example comprising wet clay) or if the oversized material does not move out of the way to the breaking machine.

Methods of clearing the blockages are generally labour intensive. For example it is known to make use of hydraulic or pneumatic impact drills, or air lances. Vibrating screens are also used and can be less likely to block up when handling dry materials, but are of limited effectiveness when handling sticky or ductile materials.

### SUMMARY OF THE DISCLOSURE

In accordance with the invention in a first aspect, a screen assembly for use in a minerals processing apparatus, and in particular with a mineral sizer which breaks mined material into a predetermined desired size range, comprises, in conventional manner:

an elongate separation screen defining an upper surface having a material reception area towards a first end and a material delivery area towards a second end, so arranged that in use material received onto the material reception area is caused to move toward the material delivery area, the separation screen having a plurality of through apertures configured such that as material so moves toward the material delivery area material components below a predetermined size tend to fall through the apertures and material components above a predetermined size continue to the material delivery area.

It is characterised in that the separation screen is provided with a cleaner device comprising a support structure having on a surface thereof a plurality of projections arrayed in coincident pattern with at least some of the through apertures in the separation screen, and in that the cleaner device is deployable between a cleaning configuration wherat the support structure is brought into close proximity below the separation screen such that the projections pass into and in the preferred case through their corresponding apertures in the separation screen and an undeployed configuration away from such close proximity.

The general principles of the separation screen itself are familiar in the art. The separation screen has an upper surface across which material to be separated moves in a material movement direction travelling generally from a reception area in the vicinity of a first end towards a second end from which it can delivered on for further processing, and for example for sizing by breaking. The screen defines a plurality of through apertures of a predetermined size through which components of the material below a predetermined size will tend to fall as the material proceeds in the movement direction. The consequence of this is that material below the predetermined size tends to fall to collection area below the separation screen before it reaches the delivery area, and thus at least a large part of the material which is already undersized bypasses the further processing stage. Oversized material does not pass through the separation screen, but continues to the material delivery area where it can be delivered for further processing, for example in a suitable breaker sizer to reduce it in size below the predetermined range.

Such an operation makes more efficient use of the breaker sizer stage, as it ensures that at least a proportion of the material which is already of a sufficiently small size and does not require further breaking is separated before this stage. However, the device will cease to work efficiently if the apertures become clogged or blocked, as might for example happen with sticky materials, as the proportion of undersized material which is successfully separated will then be reduced.

In accordance with the invention, this problem is solved by the provision of a cleaner device which enables the screen periodically to clean itself by effecting an unblocking mechanical action on material tending to obstruct the apertures. In accordance with the invention, the cleaning device may periodically be brought into close proximity with the underside of the separation screen in such manner that the projections on its surface pass into and in the preferred case through the apertures and beyond the upper surface of the screen and as a result bring mechanical force to bear on any blockage which has formed in the aperture or on the upper surface of the separation screen. This urges clear any blockage and restores the operating efficiency of the separation screen. Preferably at least some of the projections are configured to be of sufficient height that they project at least level with or more preferably beyond the upper surface of the screen when the cleaner device is fully deployed to apply a force that both tends to push off and tends to break accumulated debris on the upper surface of the separation screen.

The cleaner device is then taken out of this position to an undeployed position where the separation screen can continue to operate and undersized material can continue to fall through the apertures in the separation screen to a collection zone beneath.

The separation screen is arranged so that in use material to be separated passes in a material transfer direction from a reception area towards a first end to a delivery area towards a second end where oversized material at least partly denuded of undersized material can be passed for further processing. In a particularly convenient embodiment, this is effected in that the separation screen is angled to the horizontal in such a movement direction, from a higher point at the first end comprising the reception area to a lower point at a second end comprising the material delivery area. The separation screen thus angles downwardly relative to the horizontal in a desired material movement direction. For example, the separation screen may be angled to the horizontal at an angle of between 30° and 80° in this direction, and more preferably at an angle of between 40° to 60°. The separation screen is preferably planar, angled to the horizontal in the intended movement direction, and parallel to the horizontal in a direction transverse to the movement direction.

The effect of such an arrangement is that material tends to pass along and down the separation screen in a movement direction under the action of gravity. Oversized material continues to roll down the separation screen to the delivery area. Undersized material tends to drop through the apertures in the separation screen and be separated from the material on the surface.

Additionally or alternatively, means may be provided in association with the separation screen to urge material along in a movement direction from material reception area to the material delivery area, for example mechanically. Again, as material passes in the movement direction, oversized material remains on the surface of the separation screen and undersized material tends to fall through the apertures to a collection zone beneath.

The separation screen is preferably generally planar extending in a first elongate direction from a material reception area to a material delivery area and having sufficient width in a second direction to accommodate a satisfactory quantity of material of desired size. In a preferred case, the separation screen is preferably generally rectangular, as will be familiar. The said elongate direction then corresponds to one of the orthogonal directions of the generally rectangular screen, with the screen width in a direction orthogonal and transverse to this.

Apertures of suitable size determined by the desired size of material to be separated are preferably arrayed across at least a substantial part of the separation screen.

Apertures may extend for example in a two dimensional array, and for example a square, rectangular or hexagonal array. Apertures, particularly when in such two dimensional array, may be polygonal and for example square or rectangular.

Additionally or alternatively, apertures may comprise elongate slots, especially being elongate in a material movement direction. Elongate slots may have parallel long sides, and for example be rectangular. In a possible embodiment, elongate slots may be provided extending substantially along the whole length of the separation screen in a material movement direction. Full length elongate slots can be particularly preferred, as an arrangement of such slots means that there are no transverse aperture edges which might tend to hold up the progress of material in a movement direction. However, in other instances, two dimensional apertured arrangements might be preferred. Apertures may be arrayed in any combination of the foregoing.

Apertures extend through the thickness of the separation screen to allow undersized material to pass through them in use. In a preferred case, apertures are conveniently of constant shape and size through the thickness. In a preferred case, apertures are conveniently orthogonal to paired parallel planar faces of a planar separation screen.

The person skilled in the art will be familiar with various such arrangements of apertures in a separation screen.

The invention is distinctly characterised by the provision of a cleaner device comprising a support structure which carries a plurality of projections extending upwardly from a surface thereof which is brought into a deployed position in close proximity with a lower surface of the separation screen in use. Projections are provided in a coincident pattern with at least some of the through apertures in the separation screen so as to project through the said apertures when the support structure is brought into the deployed configuration.

Preferably, projections are arrayed to coincide with at least some of the apertures in the separation screen over at least a major part of its area and preferably substantially all of its area, so as to provide a cleaning action across such a major part of the area of the upper surface of the separation screen.

The projections are arranged upwardly from the support structure of the cleaner device. In particular, projections comprise perpendicular projections from a generally planar support structure (which term should be understood as including both continuous support plate structures and generally planar open frame support structures). Suitable shapes for the projections may be determined with reference to the shapes of the apertures in which they project. Projections may have geometrically similar shapes to the apertures in which they are intended to project, or may otherwise be determined by the shapes of such apertures.

It may be preferable to provide projections projecting through and out of substantially all the apertured area of a given aperture in the separation screen, subject to provision of suitable clearances. Alternatively, projections may be substantially smaller than and/or dissimilarly shaped to the apertures into which they project when deployed.

Projections may comprise polygonal projections, for example square or rectangular, and/or elongate projections elongate in particular in a material movement direction, for example being geometrically similar in shape to the perimeter of corresponding polygonal or elongate apertures in the separation screen.

It will be appreciated that there is a need for clearance between the inner perimeter of an aperture in the separation screen and the outer perimeter of a projection on the cleaner device to prevent jamming as the cleaner device is periodically deployed. A suitable clearance might be 6 mm at least. A clearance distance may be kept constant around the perimeter of a projection such that the projection is of a generally similar shape to the aperture into which it projects.

A projection may be tapered to a narrower perimeter dimension at its distal end and/or may be chamfered at its distal end to reduce the tendency for it to become jammed in an aperture as it is deployed. A projection may have a constant taper from a widest extent at a projection base proximal to the support structure to a narrower extent at a tip distal from the support structure. Additionally or alternatively a projection may have a step taper, for example to comprise a T-section with the cross bar of the T at the base, or to comprise an I-section with cross bars at both base and tip. A projection may comprise combinations of step and gradual tapers and may be tapered in one or two directions.

Additionally or alternatively to any profile of perimeter shape as above described, a projection may have a flat or profiled top surface. For example, a projection may have a serrated or stepped top profile. Such an arrangement may be particularly valuable for an elongate projection designed to project into an elongate slit on the separation screen.

Projections of a cleaner device in accordance with the invention may, subject to where applicable to any top profile, project generally to the same height. Alternatively, in a convenient configuration, the height of the protections may vary across the area of the surface of the cleaner device. A variable height profile may be used to ensure that first contact with obstructions is not made simultaneously across the entire area of the cleaner device, which might tend to generate an undesirable sudden load variation condition. A precise preferred distribution may vary dependent upon the relative movement direction between the cleaner device and the separation screen as the cleaner device is deployed (for example, as discussed below, whether the cleaning device is deployed in linear or rotational manner). However, in a possible embodiment the general height of the projections might tend from a minimum at either end of the cleaner device (in an elongate movement direction) to a maximum towards the middle (in an elongate movement direction).

Conveniently, the projections may be solid or hollow. The projections may be of a composite material structure having a core of a first material and an outer surface of a second material.

In accordance with the invention, the cleaner device is deployable between a deployed configuration where it sits in close proximity below the separation screen such that the projections pass through corresponding apertures to effect a cleaning action and an undeployed configuration where it is taken out of such close proximity to a position where undersized material is generally free to fall through the apertures. The apparatus conveniently further comprises a deployment drive arrangement to effect such deployment.

The deployment drive arrangement may comprise a lateral drive arrangement in which the cleaner device is deployed in linear manner into and out of its deployed position, for example in a direction perpendicular to the plane of the separation screen, or a rotational drive arrangement where the cleaner device is rotated into and out of its deployed position in close proximity to the separation screen, or a combination of the two.

In any case, the separation screen and the support structure of the cleaner device are preferably both generally planar and are deployed in such manner as to lie generally parallel in the deployed configuration such that the projections pass normally through the apertures in the separation screen to effect the said cleaning action.

Suitable lateral drive arrangements might include lateral rams such as hydraulic rams. Suitable arrangements to effect a rotational drive might include per se rotational drives such as rotary motors or suitably positioned lateral drives which effect rotation about a virtual rotational axis or combinations of the same.

In the preferred case, the cleaner device is disposed to be deployed in rotational manner about an axis beyond and preferably in close proximity to the first end of the separation screen from an undeployed configuration where it is angled away from the separation screen to a deployed configuration where it is brought into close proximity underneath the separation screen.

In a preferred configuration the axis of rotation is positioned above a notional extension of the plane of the upper surface of the separation screen. Such an axis offset tends to mean that as the cleaner device is rotated into its deployed configuration the projections carried thereon come progressively into contact with material on the upper surface, making first contact towards the first end and final contact towards the second end, which tends to reduce any undesirable sudden loading change effect. As above described, the height profile of the projections may also be progressively varied in this direction for the same purpose. Such arrangements in combination may particularly advantageously be used to balance the load experienced by the projections across the surface of the cleaner device in the deployed configuration.

The cleaner device preferably has a planar support structure carrying a suitable array of projections. The planar support structure may be an open frame structure. The support structure may comprise a rectangular frame. In the particular case, projections may be elongate in one rectangular direction, for example corresponding to a material transfer direction, and corresponding to elongate slots in the material transfer direction on the separation screen. In such a preferred case, the support structure preferably includes cross strengthening elements in a transverse direction on a back surface thereof to maintain an equal space in geometry of the cleaning projections, especially in the case of impact by heavy materials.

The cleaner device is preferably detachable from the apparatus and for example from any drive arrangement for cleaning and repair purposes.

In a possible embodiment of the invention, the screen assembly may comprise plural separation screens each provided with a cleaner device in accordance with the first aspect of the invention, and each extending from a point of closest approach corresponding to the first end of the screen, and for example comprising a common material feed area, to separate distally located second ends.

Most conveniently, such an arrangement might comprise a pair of separation screens extending outwardly from a common feed area. In the preferred case, where each separation screen is angled to the horizontal, this pair of screens may form a general inverted V shape, and for example be angled at the same angle.

Such multiple screens are able to feed multiple next stage processors such as breaker sizers during use. For example such a pair of separation screens may feed a pair of such processors from a centrally located initial material supply. Such an arrangement doubles the dead area between the two processing screens from which undersized material can be collected after falling through the screens.

Such multiple screens may use separately controlled and operated cleaner units or may use a combination cleaner unit with a common deployment drive and/or other common linkages.

In a second, more complete aspect of the invention there is additionally provided a material processing assembly comprising the foregoing screen assembly and a next stage processor downstream thereof. In particular, the next stage processor is a sizer to reduce the size of material to or below a desired size, for example by breaking, and the screen is adapted to separate out material already below this desired size. Thus, in the particular case, the material processing assembly is a mineral sizing system.

Specifically, in accordance with this further aspect of the invention there is provided a material processing assembly comprising:

a screen assembly as hereinabove described including at least one separation screen as hereinabove described;

a secondary material processor, and in particular a sizer to reduce the size of material to or below a desired size, arranged to be fed by material remaining on the surface of the separation screen at the delivery portion.

Thus, in accordance with the invention in a second aspect, oversized material is delivered to the secondary processor, but undersized material is at least partly diverted away from the processor by falling through the apertures in the separation screen from where it can be collected and conveyed onwards. Thus, it may bypass the secondary processor.

In a preferred case, the secondary processor comprises in series a material reception arrangement to receive material from a delivery portion of the separation screen, a material processor to process the material, and a material delivery system to deliver the processed material for onward supply, for example to a first material conveyor; and the assembly additionally comprises an undersized material collector to collect material which has fallen through the apertures of the separation screen and to combine this material with material delivered from the secondary processor for onward supply, for example via a second material conveyor commonly formed with or feeding into the first material conveyor.

In a particular preferred case, the secondary processor is a mineral sizer, and for example a breaker sizer. Thus, the secondary processor reduces oversized mineral to a predetermined size. The separation screen is used upstream of this sizer to separate out material which is already below the predetermined size. This material bypasses the sizer, so that, advantageously for its efficient operation, the sizer tends to process only those larger lumps of material which require further breaking to reach the predetermined size.

In a particularly preferred case, the breaker sizer comprises at least one roller and a secondary breaker surface disposed to create a breaking zone between the two breaking surfaces comprising the roller surface and the second breaker surface, in particular at the point of closest approach therebetween, at which oversized mineral can be broken, for example by crushing or in tension, in familiar manner. Preferably, at least one of the breaking surfaces is provided with a plurality of teeth. In a particularly preferred case, the breaker sizer comprises a pair of rollers, preferably contrarotating either upwardly or downwardly at the nip, and preferably both provided with breaker teeth arrayed thereon.

Suitable mineral breakers/sizers include those disclosed in European patent numbers EP0167178, EP1725335 and EP1809422.

Preferably, a material supply source is used to supply material to the material receiving part of the separation screen. Preferably, the supplied material is mined ore or overburden, or a combination of both.

In a preferred case, a pair of separation screens as hereinbefore described is disposed in an inverted V-shaped arrangement with a screen either side of a common supply source such as a common supply chute, each separation screen extending to a respective secondary material processor, and for example to a respective breaker sizer, and the common supply chute supplies material to a material reception area on each said screen.

### BRIEF DESCRIPTION OF THE DRAWINGS

The invention will now be described by way of example only with reference to FIGS. 1 to 8 of the accompanying drawings, in which:

FIG. 1 is a representation of an assembly with a pair of separation screens and a pair of rotary breaker/sizers suitable for use with a cleaner apparatus in accordance with the invention;

FIGS. 2 a and b are plan views of a typical separation screen respectively with a cleaner device in accordance with an embodiment of the invention undeployed and deployed;

FIG. 3 is an alternative arrangement of separation screen;

FIG. 4 is a schematic side view of a possible deployment of a cleaner device in accordance with an embodiment of the invention;

FIG. 5 shows the cleaning action in cross section;

FIG. 6 shows typical cleaner projections in cross section;

FIG. 7 shows two possible arrangements of a cleaner device for a dual screen apparatus;

FIG. 8 illustrates possible projection profiles for the projections on a cleaner device in accordance with an embodiment of the invention.

### DETAILED DESCRIPTION OF THE INVENTION

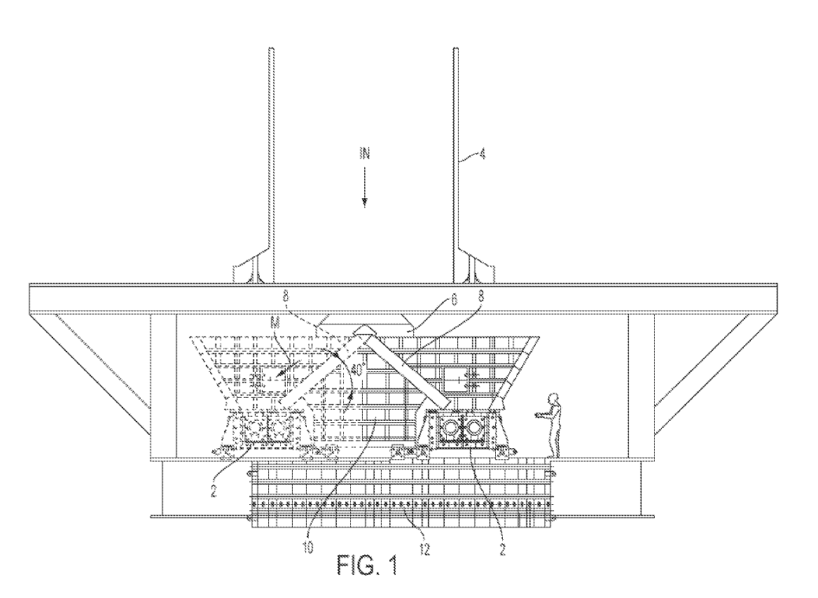

FIG. 1 illustrates a complete system for mineral sizing which could incorporate the principles of the present invention. In FIG. 1 a cleaner device in accordance with an embodiment of the present invention is not shown. FIG. 1 is primarily intended to be illustrative of an embodiment of the invention, although with the cleaner device omitted for clarity. Additionally however, FIG. 1 could be representative of a prior art system without such a cleaner device. It will be readily apparent how a cleaner device in accordance with the invention could be incorporated into the apparatus of FIG. 1 in accordance with the principles described hereinbelow. FIG. 1 therefore also provides an illustration of a particular advantage of the present invention, that it is readily available by way of aftermarket modification to existing systems.

In accordance with FIG. 1, an apparatus is shown which includes two rotary mineral breakers acting as sizers (2). Mined ore and overburden passes via the chute (4) to a common delivery point (6) where it is delivered to a pair of screens or grizzlies (8) in an inverted V-shaped arrangement.

In the embodiment the screens or grizzlies (8) are at an angle of 40° to the horizontal. Mined ore and overburden rolls down the inclined upper surface of each of these grizzlies under the action of gravity.

Size is determined by application. In the illustrated embodiment an example grizzly might be 3 m long in a material movement direction and perhaps 6 m wide. Each sizer (2) is thus in excess of 2 m from the mid-line, and the space between provides a valuable void (10) into which undersized material can fall, and in which a cleaner device can be fitted to complete an assembly in accordance with an embodiment of the invention.

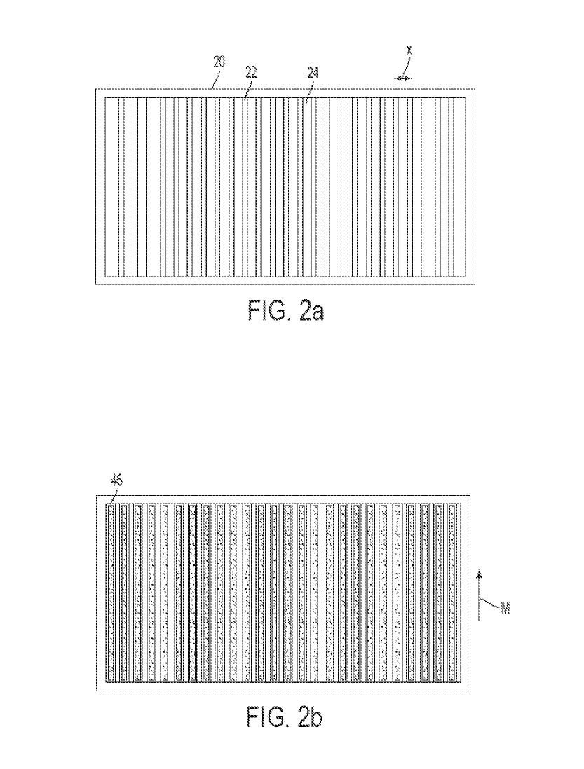

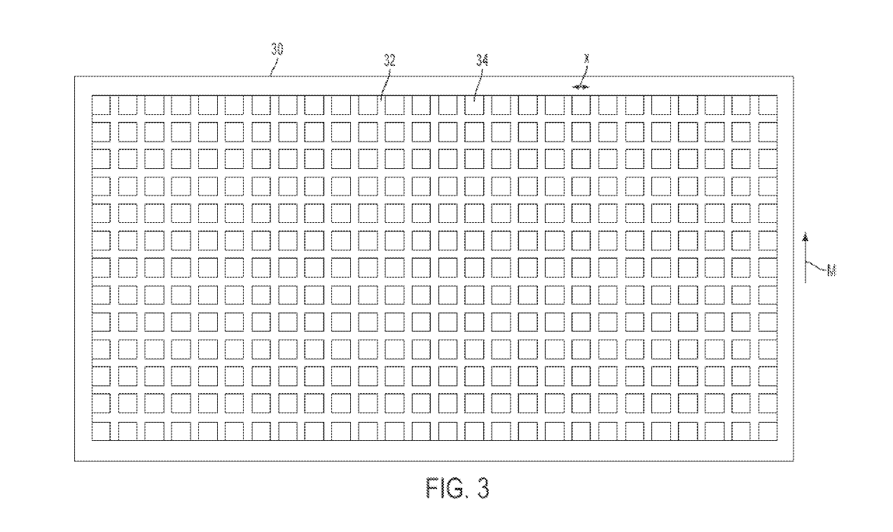

Typical grizzly configurations are illustrated in FIG. 2a and FIG. 3. In each case, the grizzly comprises a rectangular screen defined by a perimeter frame (20, 30). In FIG. 2a, a plurality of elongate bars (22) extend in a movement direction M to define a plurality of longitudinal slots (24) with a desired width x determined by the desired material screening dimension. In alternative arrangement of FIG. 3, a square grid (32) describes a square array of apertures (34) comprising squares of dimension x. In each case, the screen defines through-thickness apertures of fixed through-thickness dimension orthogonal to the respectively parallel upper and lower surfaces of the screen. Such arrangements and other arrangements will be familiar from conventional grizzlies.

The purpose of the apertures (24, 34) is to allow undersized mineral to fall through the screens under action of gravity, so that the dimensions x will be determined by the desired size. Typical dimensions for a typical application might be 80 mm or 120 mm, although an effective range from 50 mm to an upper limit of 600 mm, or even 1.5 m for a very large primary machine, could be encountered.

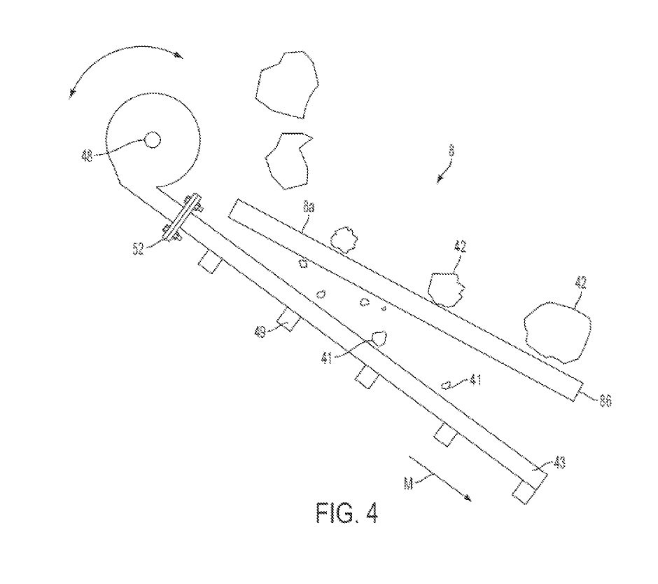

Material rolls down the grizzlies (8) under action of gravity. The result can be seen from the illustration in FIG. 4. Undersized material (41) tends to fall through the apertures in the screen (8) into the dead space (10) and onto a delivery conveyer (12), thus bypassing the breaker rollers of the sizers (2). Oversized material (42) cannot pass through the apertures and rolls down the screen upper surface from the receiving end (8a) to the delivery end (8b) from which it is delivered to the sizers (2), simply dropping under action of gravity. The action of the sizers is to reduce oversize material (42) so that it is also below a predetermined desired size. It may then similarly be delivered to the conveyer (12).

The effect of the grizzlies is to separate out at least some of the already undersized material so that it is not unnecessarily passed through the sizers (2) but instead bypasses this stage. Such principles will be familiar from the prior art. A problem arises if the apertures (24, 34) become blocked. In those circumstances, a greater proportion of undersized material (41) is likely to fail to separate as the material progresses down the grizzly, reducing the efficiency of operation. An embodiment of the invention which addresses this problem may be illustrated with particular reference to FIGS. 2b, 4 and 5.

Referring first to FIG. 4, a paddle arm (43) is shown which consists of a support structure generally coextensive with the grizzly (8). The paddle arm carries a plurality of parallel projecting teeth which are in this case fingers that are elongate in a direction parallel to and correspond to and in the deployed configuration engage within the apertures (24) of the screen illustrated in FIG. 2a. This is shown in FIG. 2b, where the elongate array of projections (46) is shown received within the corresponding apertures. In the case of the embodiment illustrated in FIG. 2, each aperture is 120 mm wide and the fingers are sized to give an aperture/finger clearance of at least 6 mm on either side.

Transverse reinforcement bars (49) give extra rigidity to the structure and in particular help maintain equal spacing geometry of the cleaning fingers, especially in the event of impact by heavy falling material.

The paddle (43) is mounted for rotation about an axis (48). A suitable drive (not shown) brings the paddle into a deployed configuration at the under surface of the grizzly (8) where the fingers engage in the manner illustrated in FIG. 2b, and back to an undeployed configuration where the paddle is free of the under surface of the grizzly (8) and undersized material (41) can fall freely into the zone (10).

A bolted joint (52) may removably attach the paddle arm (43) to the axis mounting, for example to facilitate maintenance and repair.

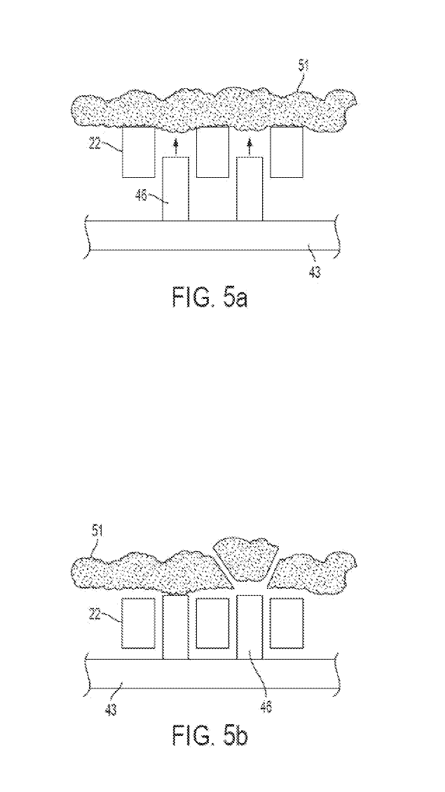

The cleaning action is illustrated more particularly in FIG. 5. In FIG. 5a, debris (51) is shown to have built up on the upper surface of the screen elements (22), blocking the apertures in the screen. The paddle (43) is brought into close proximity to the under surface of the screen. As the projecting fingers (46) push into the apertures and in the illustrated example through and beyond the upper surface of the screen, the debris is broken free. The projecting fingers (46) are configured to be of sufficient height that they project either level with or beyond the upper surface of the screen when the paddle (43) is fully deployed to apply a force that both tends to push off and tends to break accumulated debris on the surface.

Once cleaning has been effected, the paddle is removed from the under side of the screen to an undeployed configuration so that the screen can once more function unhindered and allow undersized material to fall through.

Since the projecting fingers (46) of the paddle (43) effectively block the screen in the deployed configuration, it is generally desirable that the period during which the paddle is in the deployed configuration is short relative to the overall operational time. This may simply be achieved in that the paddle is deployed periodically under suitable control means. Alternatively, an arrangement of continuous drive might be envisaged which still ensures that the paddle spends most of the time in an undeployed condition in a position at which the separation screen can function to separate undersized material.

The drive means are not specifically pertinent to the invention. In the embodiment of FIG. 4, or any other case where a cleaner device according to the invention was deployed rotationally, a per se rotary drive could be envisaged in which the paddle is physically rotated about a physical axis (48) and the drive acts at, proximal to or about the physical axis (48). Any powered drive could be used, such as hydraulic motors, electric motors, pneumatic motors etc. The rotary drive may include gearing to vary the speed of oscillation into and out of the deployed position. The rotary drive may include mechanical or electrical linkages or other electrical controls to reverse direction of the drive to undeploy the paddle.

Additionally or alternatively, lateral drives such as hydraulic rams, remote from the axis and for example at a distal end of the paddle (43) might be used to effect deployment about the axis (48).

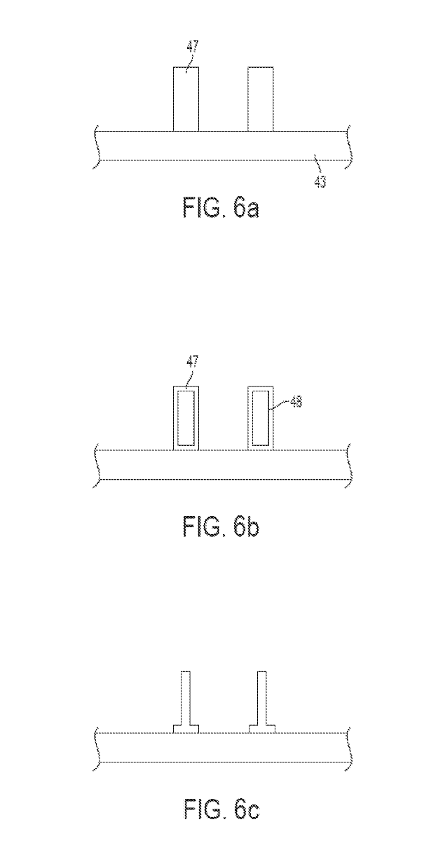

The embodiment of FIG. 2, in which elongate finger teeth generally fill elongate slots extending the full length of the screen in a movement direction M, save only for the provision of adequate clearance to prevent jamming, is merely one of a range of possible arrangements. Other arrays of apertures and arrays of teeth either corresponding to those holes in geometrically similar manner or having dissimilar but still effective shapes can be envisaged. FIGS. 6a to 6c represent merely some examples of minor variations on the embodiment of FIG. 2. In FIG. 6a, the paddle (43) carries simple teeth (46) which are rectangular in cross section. In FIG. 6b the teeth (47) are hollow. In an alternative arrangement, the hollow cavity (48) could instead consist of a secondary material. FIG. 6c illustrates a T-shaped profile with the cross piece at the base. Alternative profiles could be envisaged. For example, an I-shape with top and bottom cross pieces might be preferred. A tapered profile, or a profile in which teeth were given a chamfered top edge might be considered.

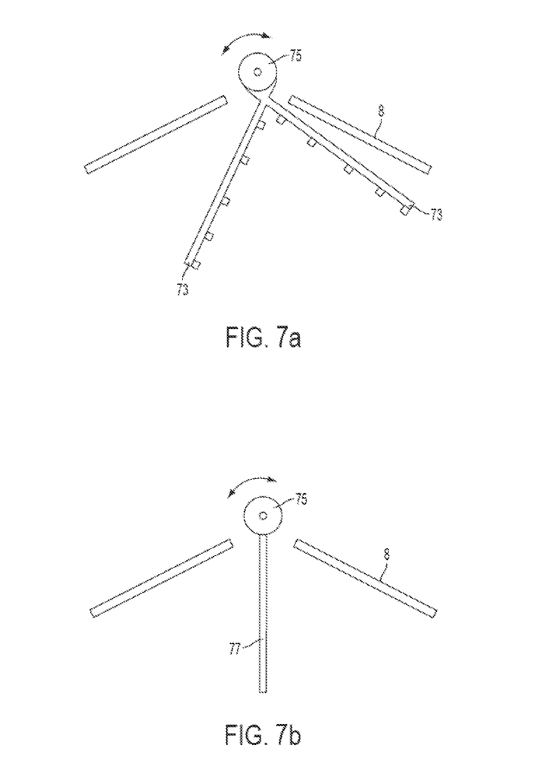

FIG. 7 illustrates two possible alternative embodiments of arrangement of paddle for the twin screen apparatus illustrated in FIG. 1, provided with a common drive assembly (not specifically shown). In the first embodiment, a pair of paddles (73) is mounted on a common drive means (75). As the drive means rotates to and fro one or other paddle is brought selectively into a deployed position and acts to clean its respective screen (8). In FIG. 7b a single paddle (77) is shown, which rotates to and fro to clear each screen in turn. The former arrangement gives a better balance of forces, and might require a less powerful drive, but represents more of an obstruction in the area below the two screens (8) when undeployed.

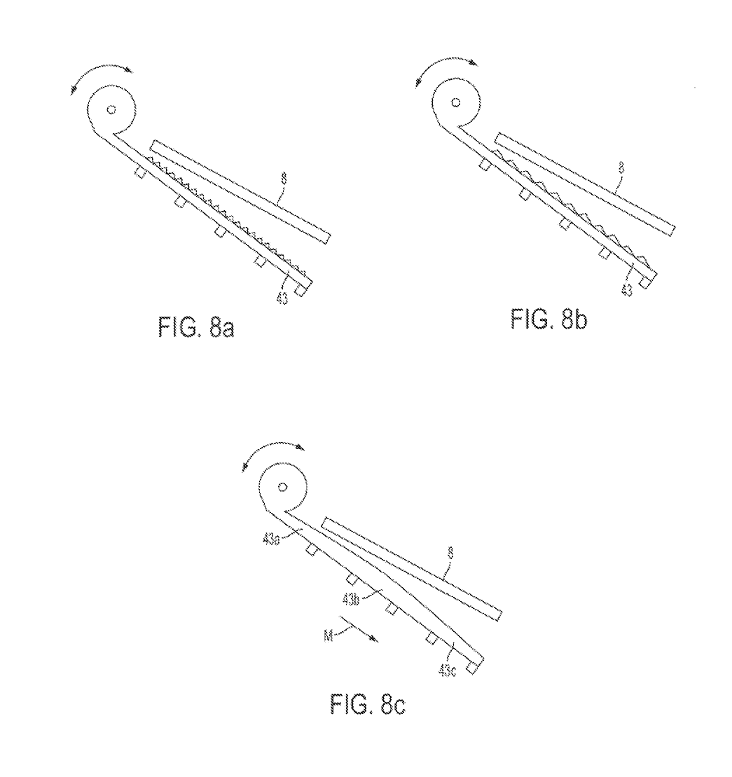

The embodiments illustrated in FIGS. 2 and 4 to 7 assume fingers extend in an elongate manner that correspond to the elongate slots in a movement direction in the screens (8) to present a flat upper surface of uniform height. Alternative arrangements are illustrated in FIG. 8. In FIG. 8a, the upper surfaces of the fingers are symmetrically serrated. In FIG. 8b an asymmetric serration is shown. This is potentially even more advantageous, as it produces a tendency to urge material downwards as the cleaner paddle first comes into the deployed position and the teeth first come into contact with the debris to be cleared. In both cases, a uniform height along the length of the paddle is envisaged. In FIG. 8c, the height of a finger varies along the length of the paddle in a movement direction M. Tooth height is at its greatest towards the middle of the length of the paddle (43) in the middle portion (43b) and reduces progressively towards the proximal and distal ends of the paddle, respectively (43a and 43c).

It will be appreciated that the alternatives illustrated in FIGS. 6 and 8 are merely examples of possible projecting tooth profile, that the principles embodied therein could be combined in any way, and similarly combined with other varied profiles, and that none of these alternatives is limited to an embodiment such as that illustrated in FIG. 2 where parallel elongate finger teeth extend substantially the entire length of the paddle. The principles of the invention are applicable to separation screens with a wide range of aperture design and configuration, and require merely that a cleaner device embodying the principles of the invention includes any suitably arrayed configurations of projecting teeth that can be effective in removing debris from an upper surface of the screen when the cleaner device is brought into close proximity with the lower surface such that the teeth project through apertures and tend to urge that debris free of the upper surface.

What is claimed is:

1. A screen assembly for use in a minerals processing apparatus comprising:
an elongate separation screen defining an upper surface having a material reception area towards a first end and a material delivery area towards a second end, so arranged that in use material received onto the material reception area is caused to move toward the material delivery area, the separation screen having a plurality of through apertures configured such that as material so moves toward the material delivery area material components below a predetermined size tend to fall through the apertures and material components above a predetermined size continue to the material delivery area;
wherein the separation screen is provided with a cleaner device comprising a support structure having on a surface thereof a plurality of projections arrayed in coincident pattern with at least some of the through apertures in the separation screen, and in that the cleaner device is deployable between a cleaning configuration whereat the support structure is brought into close proximity below the separation screen such that the projections into their corresponding apertures in the separation screen and an undeployed configuration away from such close proximity.

2. A screen assembly in accordance with claim 1 wherein the separation screen is angled to the horizontal in a material transfer direction downwardly from a reception area towards a first end to a delivery area towards a second end

3. A screen assembly in accordance with claim 2 angled to the horizontal at an angle of between 30° and 80°, and more preferably at an angle of between 40° to 60°.

4. A screen assembly in accordance with claim 1 wherein the separation screen is generally rectangular.

5. A screen assembly in accordance with claim 1 wherein the apertures in the separation screen extend in a two dimensional array, and are polygonal and for example square or rectangular, in shape.

6. A screen assembly in accordance with claim 1 wherein the apertures in the separation screen are elongate in a material movement direction.

7. A screen assembly in accordance with claim 6 wherein the elongate apertures are elongate slots with parallel long sides extending substantially along the whole length of the separation screen in a material movement direction.

8. A screen assembly in accordance with claim 1 wherein the cleaner device carries a plurality of projections extending upwardly from a surface thereof and which are arrayed to coincide with at least some of the apertures in the separation screen over substantially all of its area.

9. A screen assembly in accordance with claim 1 wherein at least some of the projections are configured to be of sufficient height that they project at least level with the upper surface of the screen when the cleaner device is fully deployed.

10. A screen assembly in accordance with claim 9 wherein at least some of the projections are configured to be of sufficient height that they project beyond the upper surface of the screen when the cleaner device is fully deployed.

11. A screen assembly in accordance with claim 1 wherein the cleaner device carries a plurality of projections extending perpendicularly from a generally planar support structure.

12. A screen assembly in accordance with claim 1 wherein the projections on the cleaner device have geometrically similar shapes to the apertures in which they are intended to project.

13. A screen assembly in accordance with claim 1 wherein the projections on the cleaner device vary in height across the area of the surface of the cleaner device.

14. A screen assembly in accordance with claim 1 wherein the separation screen and the support structure of the cleaner device are both generally planar and are deployed in such manner as to lie generally parallel in the deployed configuration such that the projections pass normally through the apertures in the separation screen to effect the said cleaning action.

15. A screen assembly in accordance with claim 1 further comprising a deployment drive to effect deployment of the cleaner device to a deployed configuration in the form of a rotational drive arrangement by means of which the cleaner device is rotated into and out of its deployed position in close proximity to the separation screen.

16. A screen assembly in accordance with claim 15 wherein the cleaner device is disposed to be deployed in rotational manner about an axis beyond and in close proximity to the first end of the separation screen from an undeployed configuration where it is angled away from the separation screen to a deployed configuration where it is brought into close proximity underneath the separation screen.

17. A screen assembly in accordance with claim 16 wherein the axis of rotation is positioned above a notional extension of the plane of the upper surface of the separation screen.

18. A screen assembly comprising plural separation screens each provided with a cleaner device in accordance with any preceding claim, the screens extending from a point of closest approach corresponding to their respective first ends to separate distally located second ends.

19. A screen assembly in accordance with claim 18 comprising a pair of separation screens extending outwardly from a common feed area.

20. A screen assembly in accordance with claim 19 wherein the pair of screens forms an inverted V shape, each screen angled at the same angle to the horizontal.

21. A material processing assembly comprising:
a screen assembly in accordance with any preceding claim including at least one separation screen in accordance with any preceding claim;
a secondary material processor arranged to be fed by material remaining on the surface of the separation screen at the delivery portion.

22. A material processing assembly in accordance with claim 21 wherein the secondary processor comprises in series a material reception arrangement to receive material from a delivery portion of the separation screen, a material processor to process the material, and a material delivery system to deliver the processed material for onward supply, for example to a first material conveyor; and wherein the assembly additionally comprises an undersized material collector to collect material which has fallen through the apertures of the separation screen and to combine this material with material delivered from the secondary processor for onward supply.

23. A material processing assembly in accordance with claim 21 wherein the secondary processor is a mineral sizer.

24. A material processing assembly in accordance with claim 23 wherein the mineral sizer is a breaker sizer comprising at least one roller and a secondary breaker surface disposed to create a breaking zone between the two breaking surfaces comprising the roller surface and the second breaker surface, in particular at the point of closest approach therebetween, at which oversized mineral can be broken, for example by crushing or in tension.

25. A material processing assembly in accordance with claim 24 wherein the breaker sizer comprises a pair of contrarotating rollers defining a pair of breaking surfaces in particular at the point of closest approach therebetween.

26. A material processing assembly in accordance with claim 24 wherein at least one of the breaking surfaces is provided with a plurality of teeth.
